(19) United States
(12) Patent Application Publication
(10) Pub. No.: US 2010/0042774 A1
(43) Pub. Date: Feb. 18, 2010

(54) BLOCK MANAGEMENT METHOD FOR FLASH MEMORY, AND STORAGE SYSTEM AND CONTROLLER USING THE SAME

(75) Inventors: Jiunn-Yeong Yang, Keelung City (TW); Chien-Hua Chu, Hsinchu County (TW); Chih-Kang Yeh, Kinmen County (TW); Kuang-Tung Fang, Kaohsiung City (TW); Jui-Hsien Chang, Taipei County (TW)

Correspondence Address: J C PATENTS, 4 VENTURE, SUITE 250, IRVINE, CA, 92618, US

(73) Assignee: PHISON ELECTRONICS CORP., Miaoli (TW)

(21) Appl. No.: 12/265,429

(22) Filed: Nov. 5, 2008

(30) Foreign Application Priority Data
Aug. 15, 2008 (TW) 97131233

(51) Int. Cl. G06F 12/02; G06F 12/00

(52) U.S. Cl. 711/103; 711/E12.001; 711/E12.008

(57) ABSTRACT

A block management method for a flash memory chip having multiple planes is provided, wherein each plane has a plurality of physical blocks. The method includes disposing a plurality of physical units, wherein each physical unit includes a physical block of each plane, and the physical blocks in the physical unit have a simultaneously-operable relationship. The method also includes writing data in a single plane access mode when a host system does not update all the physical blocks in an updated the physical unit. The method further includes writing the data in a multi-planes access mode when the host system updates all the physical blocks in the updated physical unit, wherein the physical blocks for writing the data have the simultaneously-operable relationship.

### CROSS-REFERENCE TO RELATED APPLICATION

This application claims the priority benefit of Taiwan application serial no. 97131233, filed on Aug. 15, 2008. The entirety of the above-mentioned patent application is hereby incorporated by reference herein and made a part of specification.

### BACKGROUND

1. Field of the Invention

The present invention generally relates to a block management method for a flash memory, and more particularly, to a block management method for a flash memory chip having multiple planes, and a storage system and a controller using the same.

2. Description of Related Art

Along with the widespread of digital cameras, camera phones, and MP3 in recently years, the consumers' demand to storage media has increased drastically too. Flash memory is one of the most adaptable memories for such battery-powered products due to its characteristics such as data non-volatility, low power consumption, small volume, and non-mechanical structure. For example, a solid state drive (SSD) is a storage device which uses a NAND flash memory as its storage medium.

Generally speaking, a flash memory chip of a flash memory storage system is divided into a plurality of physical units, and each of the physical units is composed of one or more physical blocks. The physical units are grouped into a data area and a spare area. Physical units in the data area store valid data written by write commands, and physical units in the spare area are used for substituting the physical units in the data area when the write commands are executed. To be specific, when a flash memory storage system receives a write command from a host system and is about to write data into a physical unit in the data area, the flash memory storage system selects a physical unit from the spare area and writes both the old valid data stored in the original physical unit to be written in the data area and the new data into the physical unit selected from the spare area. Then the flash memory storage system links the physical unit containing the new data to the data area. After that, the flash memory storage system erases the original physical unit and links it to the spare area. In order to allow the host system to access the physical units which are alternatively used for storing data, logical units are disposed in the flash memory storage system to be accessed by the host system. Namely, a logical-physical address mapping table is established in the flash memory storage system for recoding and updating the mapping relationship between the logical units and the physical units grouped to the data area and accordingly reflecting the alternation of the physical blocks. Thereby, the host system simply writes data into a logical unit, and the flash memory storage system writes the data into the corresponding physical unit according to the logical-physical address mapping table.

However, the capacity of each physical block has been increased along with the advancement of flash memory process. As a result, the time for moving foregoing old valid data is increased relatively. Particularly, in a flash memory storage system having a flash memory chip with multiple planes (i.e., each physical unit in the flash memory chip includes a plurality of physical blocks), the flash memory storage system considers those physical blocks having a simultaneously-operable relationship in the planes as a physical unit and simultaneously accesses the physical blocks of different planes in the same physical unit (referred as “multi-planes access”), so as to increase the speed of data access. While writing data in a flash memory storage system with multi-plane access technique, foregoing time-consuming data moving operations have to be performed to the physical blocks belonged to one physical unit. As a result, the time for writing data in the flash memory chip is drastically increased, and accordingly, the time required by the flash memory storage system to respond to the write command of the host system far exceeds the specification of the host system so that a time out problem is caused.

### SUMMARY

Accordingly, the present invention is directed to a block management method which can improve data writing efficiency and reduce unnecessary data moving so as to avoid a time out error.

The present invention is directed to a controller which manages a flash memory through foregoing block management method, wherein data writing efficiency is improved and unnecessary data moving is reduced, and accordingly, a time out error is avoided.

The present invention is further directed to a storage system which manages a flash memory through foregoing block management method, wherein data writing efficiency is improved and unnecessary data moving is reduced, and accordingly, a time out error is avoided.

One principle aspect of the present invention provides a block management method. The block management method includes providing a flash memory chip, wherein the flash memory chip has a first plane and a second plane, and the first plane and the second plane respectively have a plurality of physical blocks. The block management method also includes disposing a plurality of physical units, wherein each of the physical units includes one of the physical blocks of the first plane and one of the physical blocks of the second plane, and the physical block of the first plane and the physical block of the second plane in each of the physical units have a simultaneously-operable relationship. The block management method further includes determining whether a host system is about to write data only into the physical block of the first plane in one of the physical units when the host system is about to write the data into the one of the physical units. The data is written into the physical block of the first plane in the one of the physical units in a single plane access mode when the host system is about to write the data only into the physical block of the first plane in the one of the physical units, and the data is written into the physical block of the first plane and the physical block of the second plane in the one of the physical units in a multi-planes access mode when the host system is not about to write the data only into the physical block of the first plane in the one of the physical units, wherein the physical block of the first plane and the physical block of the second plane for writing the data have the simultaneously-operable relationship.

Another aspect of the present invention provides a flash memory storage system and a controller thereof. The flash memory storage system includes a flash memory chip, a connector, and a controller. The flash memory chip has a first plane and a second plane, and the first plane and the second plane respectively have a plurality of physical blocks. The controller is electrically connected to the flash memory chip and the connector. The controller includes a microprocessor unit, a flash memory interface module coupled to the microprocessor unit, a buffer memory, a host interface module, and a memory management module. In particular, the memory management module has a plurality of machine instructions, which when executed by the microprocessor unit, to perform foregoing block management method to the flash memory.

Additional aspect of the present invention provides a block management method. The block management method includes providing a flash memory chip, wherein the flash memory chip has multiple planes, and each of the planes has a plurality of physical blocks. The block management method also includes disposing a plurality of physical units, wherein each of the physical units includes one of the physical blocks of each plane, and the physical blocks in one of the physical unit have a simultaneously-operable relationship. The block management method further includes determining whether a host system is about to write data into all the physical blocks in the one of the physical units when the host system is about to write data into the one of physical units. The data is written in a single plane access mode when the host system is not about to write the data into all the physical blocks in the one of the physical units, and the data is written in a multi-planes access mode when the host system is about to write the data into all the physical blocks in the one of the physical units, wherein the physical blocks for writing the data have the simultaneously-operable relationship.

In the present invention, data is written into a flash memory chip having multiple planes in a single plane access mode or a multi-planes access mode according to the address distribution of the physical blocks for writing the data. Thereby, the speed for writing the data is increased, and meanwhile, the time out problem caused by unnecessary data moving is avoided.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic block diagram of a flash memory storage system according to an exemplary embodiment of the present invention.

FIG. 2 is a block diagram of a flash memory chip according to an exemplary embodiment of the present invention.

FIGS. 3A and 3B are diagrams illustrating the operations of physical blocks according to an exemplary embodiment of the present invention.

FIG. 4 is a diagram illustrating how to write data into a flash memory chip in a multi-planes access mode according to an exemplary embodiment of the present invention.

FIG. 5 is a diagram illustrating how to write data into a flash memory chip in a single plane access mode according to an exemplary embodiment of the present invention.

FIG. 6 is a flowchart of a block management method according to an exemplary embodiment of the present invention.

### DESCRIPTION OF THE EXEMPLARY EMBODIMENTS

Reference will now be made in detail to the present preferred exemplary embodiments of the invention, examples of which are illustrated in the accompanying drawings. Wherever possible, the same reference numbers are used in the drawings and the description to refer to the same or like parts.

In order to access a flash memory chip with multiple planes by using multi-planes access techniques and to avoid the time out problem caused when small quantity of data (for example, single sector data) is written, in the present invention, those physical blocks having a simultaneously-operable relationship in each plane of the flash memory chip are respectively disposed as a plurality of physical units, and when a host system is about to write data into the physical units, whether the host system is about to write the data into all the physical blocks belonged to the same physical unit is determined, wherein the data is written in a single plane access mode when the host system is not about to write the data into all the physical blocks belonged to the same physical unit, and the data is written into physical blocks having the simultaneously-operable relationship in a multi-planes access mode when the host system is about to write the data into all the physical blocks belonged the same physical unit. Exemplary embodiments of the present invention will be described in detail below.

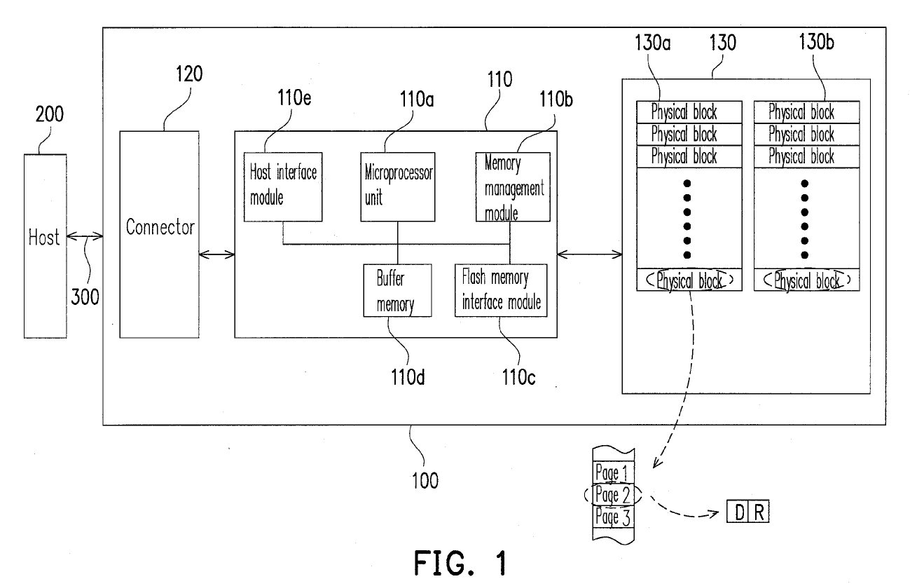

FIG. 1 is a schematic block diagram of a flash memory storage system according to an exemplary embodiment of the present invention. Referring to FIG. 1, the flash memory storage system 100 includes a controller (also referred to as a controller system) 110, a connector 120, and a flash memory chip 130.

The flash memory storage system 100 is usually used together with a host system 200 to allow the host system 200 to write data into or read data from the flash memory storage system 100. In the present exemplary embodiment, the flash memory storage system 100 is a memory card. However, in another exemplary embodiment of the present invention, the flash memory storage system 100 may also be a solid state drive (SSD) or a flash drive.

The controller 110 executes a plurality of instructions which are implemented as hardware or firmware in order to cooperate with the connector 120 and the flash memory chip 130 for storing, reading, and erasing data. The controller 110 includes a microprocessor unit 110a, a memory management module 110b, a flash memory interface module 110c, a buffer memory 110d, and a host interface module 110e.

The microprocessor unit 110a cooperates with the memory management module 110b, the flash memory interface module 110c, the buffer memory 110d, and the host interface module 110e to carry out various operations of the flash memory storage system 100.

The memory management module 110b is coupled to the microprocessor unit 110a. The memory management module 110b has a plurality of machine instructions which can be executed by the microprocessor unit 110a to manage the flash memory chip 130, such as machine instructions for performing a wear levelling function, managing blocks, and maintaining a logical-physical address mapping table, etc. In particular, in the present exemplary embodiment, the memory management module 110b includes machine instructions which can be executed to accomplish the block management steps provided by the present exemplary embodiment.

In the present exemplary embodiment, the memory management module 110b is stored in the controller 110 as a firmware, such as machine instructions written in a programming language and stored in a program memory (for example, a real-only memory (ROM)). When the flash memory storage system 100 is in operation, the machine instructions of the memory management module 110b are indirectly loaded into the buffer memory 110d and executed by the microprocessor unit 110a or directly executed by the microprocessor unit 110a to accomplish foregoing wear levelling function, bad block management function, and logical-physical address mapping table maintenance function etc. In particular, the controller 110 accomplishes the block management steps in the present exemplary embodiment by executing a plurality of machine instructions of the memory management module 110b.

In another exemplary embodiment of the present invention, the machine instructions of the memory management module 110b may also be stored in a specific area of the flash memory chip 130 (for example, a system area in the flash memory chip 130 for storing system data exclusively) as a firmware. Similarly, when the flash memory storage system 100 is in operation, the machine instructions of the memory management module 110b are loaded into the buffer memory 110d and executed by the microprocessor unit 110a. Additionally, in another exemplary embodiment of the present invention, the memory management module 110b may also be disposed in the controller 110 as a hardware.

The flash memory interface module 110c is coupled to the microprocessor unit 110a for accessing the flash memory chip 130. In other words, data to be written into the flash memory chip 130 is converted by the flash memory interface module 110c into a format acceptable to the flash memory chip 130.

The buffer memory 110d is coupled to the microprocessor unit 110a for temporarily storing system data (for example, the logical-physical address mapping table) or data to be read or written by the host system 200. In the present exemplary embodiment, the buffer memory 110d is a static random access memory (SRAM). However, the present invention is not limited thereto, and a dynamic random access memory (DRAM), a magnetoresistive random access memory (MRAM), a phase change random access memory (PRAM), or other suitable memories may also be applied in the present invention.

The host interface module 110e is coupled to the microprocessor unit 110a for receiving and identifying instructions received from the host system 200. In other words, instructions and data sent by the host system 200 are sent to the microprocessor unit 110a through the host interface module 110e. In the present exemplary embodiment, the host interface module 110e is a SD interface. However, the present invention is not limited thereto, and the host interface module 110e may also be a USB interface, an IEEE 1394 interface, a PCI Express interface, a MS interface, a MMC interface, a SATA interface, a CF interface, an IDE interface, or other suitable data transmission interfaces. In particular, the host interface module 110e is corresponding to the connector 120. Namely, the host interface module 110e has to match the connector 120.

In addition, even though not shown in the present exemplary embodiment, the controller 110 may further include other general function modules for controlling the flash memory, such as an error correction module and a power management module.

The connector 120 is used for connecting to the host system 200 through a bus 300. In the present exemplary embodiment, the connector 120 is a SD connector. However, the present invention is not limited thereto, and the connector 120 may also be a USB connector, an IEEE 1394 connector, a PCI Express connector, a MS connector, a MMC connector, a SATA connector, a CF connector, an IDE connector, or other suitable connectors.

The flash memory chip 130 is electrically connected to the controller 110 for storing data. In the present exemplary embodiment, the flash memory chip 130 is a multi level cell (MLC) NAND flash memory. However, the present invention is not limited thereto, and in another exemplary embodiment of the present invention, the flash memory chip 130 may also be a single level cell (SLC) NAND flash memory.

In the present exemplary embodiment, the flash memory chip 130 includes a first plane 130a and a second plane 130b. The first plane 130a and the second plane 130b respectively include a plurality of physical blocks. In particular, the first plane and the second plane may be physically or virtually divided.

In a flash memory, data is erased in unit of physical blocks. Namely, each physical block contains the smallest number of memory cells which are erased together. Each physical block is usually divided into a plurality of pages. A page is usually the smallest programming unit. However, it should be noted that in some different flash memory designs, the smallest programming unit may also be a sector. Namely, a page has a plurality of sectors and each sector is served as the smallest programming unit. In other words, a page is the smallest unit for reading and writing data. Each page is usually divided into a user data area D and a redundant area R, wherein the user data area D is used for storing user data, and the redundant area R is used for storing system data (for example, an error correcting code (ECC)).

Generally speaking, the user data area D has 512 bytes and the redundant area R has 16 bytes in order to correspond to the size of sectors in a disk drive. In other words, a page is a sector. However, a page may also be composed of a plurality of sectors. In the present exemplary embodiment, a page in a flash memory block is composed of four sectors.

Generally speaking, a physical block can be composed of any number of pages, such as 64 pages, 128 pages, and 256 pages. In addition, the physical blocks in the first plane 130a or the second plane 130b are usually grouped into several zones. By managing operations of a flash memory based on zones, parallelism of the operations can be increased and the management thereof can be simplified.

Additionally, the controller 110 disposes and manages some physical blocks in the first plane 130a and the second plane 130b as a physical unit. For example, a physical unit includes two physical blocks. By managing a flash memory in physical units, the required space of the buffer memory 110d is reduced because the controller 110 maintains the logical-physical address mapping table in larger units (i.e., the physical units).

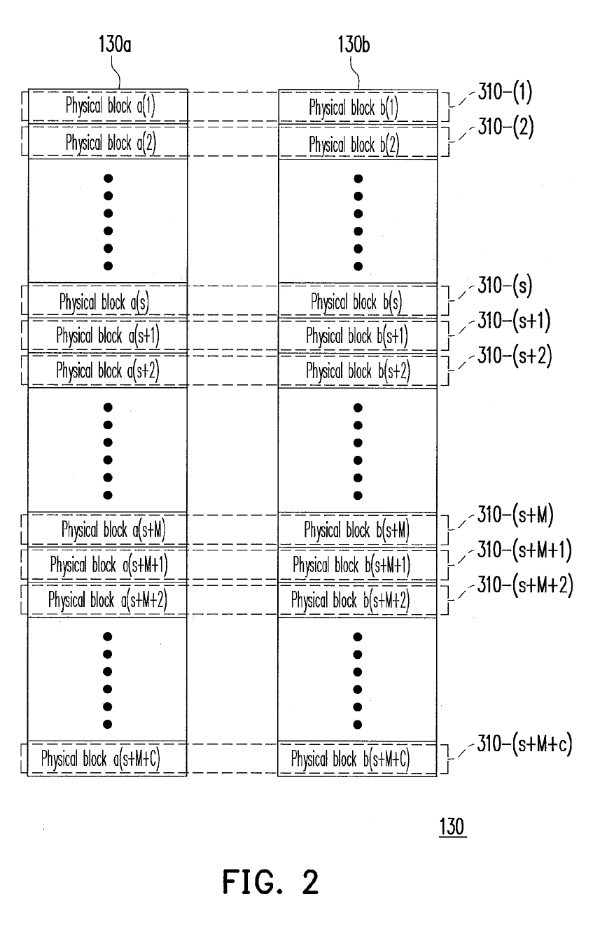

Particularly, in the present exemplary embodiment, the controller 110 can simultaneously access specific physical blocks of the first plane 130a and the second plane 130b in a multi-planes access mode. Namely, a specific physical block of the first plane 130a and a specific physical block of the second plane 130b in the flash memory chip 130 can be simultaneously operated by a multi-planes access command (for example, for executing data writing, reading, and erasing). Thus, in the present exemplary embodiment, the controller 110 respectively disposes the physical blocks having the simultaneously-operable relationship into a physical unit. To be specific, a specific circuit design of the flash memory chip allows some planes to access data with at least partially overlapped (or synchronous) operation time so as to shorten the time required for accessing the data. Herein these planes which can access data with partially synchronous operation time are referred to as planes having a simultaneously-operable relationship, and the mode in which data is accessed in the partially synchronous pattern is referred to as a multi-planes access mode. FIG. 2 is a block diagram of a flash memory chip according to an exemplary embodiment of the present invention. Referring to FIG. 2, the physical blocks of the first plane 130a and the second plane 130b are respectively grouped into physical units 310-1˜310-(S+M+C).

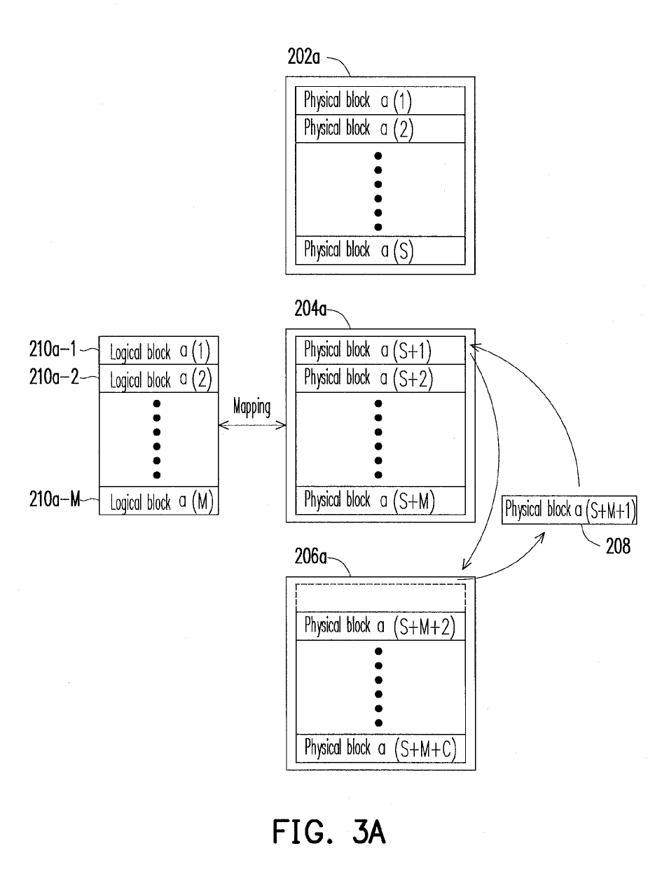

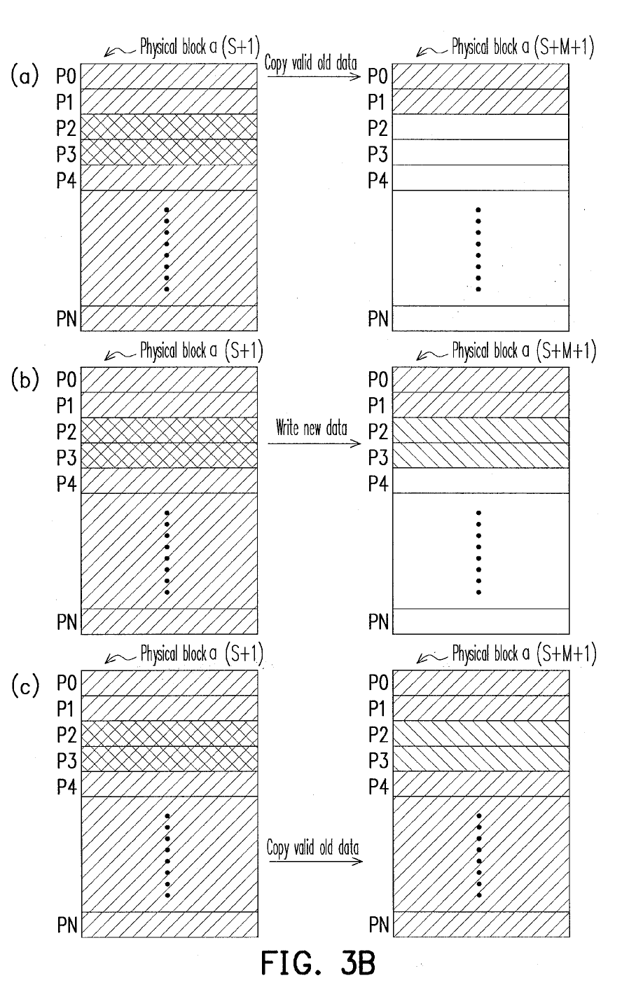

FIGS. 3A and 3B are diagrams illustrating the operations of physical blocks in the first plane 130a (or the second plane 130b) according to an exemplary embodiment of the present invention.

It should be understood that the terms such as “select”, “move”, “exchange”, “substitute”, “alternate”, “divide”, and “group” used in the present disclosure only refer to operations performed logically on the physical blocks in the flash memory chip 130. Namely, the actual positions of the physical blocks in the flash memory chip 130 are not changed; instead, these operations are only performed logically to the physical blocks in the flash memory chip 130. It should be mentioned herein that the following operations preformed on the physical blocks are accomplished by executing the machine instructions of the memory management module 110b through the controller 110.

The physical blocks in the first plane 130a and the second plane 130b have the same operations. Accordingly, the first plane 130a will be described herein as an example. Referring to FIG. 3A, in the present exemplary embodiment, in order to program (i.e., write) data effectively, the controller 110 logically groups the physical blocks of the first plane 130a into a system area 202a (i.e., the physical blocks a(1)˜a(S)), a data area 204a (i.e., the physical blocks a(S+1)˜a(S+M)), and a spare area 206a (i.e., the physical blocks a(S+M+1)˜a(S+M+C)). As described above, the physical blocks of the first plane 130a are alternatively provided to the host system for storing data. Thus, the controller 110 provides logical blocks 210a-1˜210a-M to the host system for accessing data and records the mapping relationship between the physical blocks and the logical blocks by maintaining a logical-physical address mapping table. In the present exemplary embodiment, foregoing S, M, and C are positive integers respectively representing the numbers of physical blocks in foregoing areas, and the values thereof can be determined according to the capacity of the flash memory by a manufacturer of the flash memory storage system.

Physical blocks in the system area 202a are used for storing system data, such as the number of zones in the first plane 130a, the number of physical blocks in each zone, the number of pages in each physical block, and the logical-physical address mapping table for recording the mapping relationship between the logical blocks and the physical blocks, etc.

Physical blocks in the data area 204a are used for storing user data, and these physical blocks are usually the blocks corresponding to the logical blocks accessed by the host system 200.

Physical blocks in the spare area 206a are used for substituting the physical blocks in the data area 204a. Thus, the physical blocks in the spare area 206a are blank or available blocks, namely, no data is recorded in these blocks or data recorded in these blocks has been marked as invalid data.

Particularly, the physical blocks in the data area 204a and the spare area 206a are alternatively used for storing data written by the host system 200 into the flash memory storage system 100. To be specific, each address in a flash memory can only be programmed once, and accordingly, an erasing operation has to be performed to an address which already contains data before a new data is written into this address. However, as described above, data is written into a flash memory in unit of pages while erased from the same in unit of physical blocks. Since the writing unit is smaller than the erasing unit, when a physical block is to be erased, data in valid pages of the physical block has to be copied to another physical block before the physical block is erased.

For example, when the host system is about to write a data into the logical block 210a-1 (i.e., the logical block a(1)), the controller 110 obtains that the logical block a(1) is currently mapped to the physical block a(S+1) in the data area 204a through the logical-physical address mapping table. Thus, the flash memory storage system 100 updates the data in the physical block a(S+1). Meanwhile, the controller 110 selects the physical block a(S+M+1) from the spare area 206a for substituting the physical block a(S+1) in the data area 204a. However, when the new data is written into the physical block a(S+M+1), not all the valid data in the physical block a(S+1) is instantly moved to the physical block a(S+M+1) to erase the physical block a(S+1). To be specific, the controller 110 copies the data before the page for writing the new data in the physical block a(S+1) (i.e., the pages P0 and P1) to the physical block a(S+M+1) (as shown in FIG. 3B(a)) and writes the new data (i.e., pages P2 and P3 in the physical block a(S+M+1)) to the physical block a(S+M+1) (as shown in FIG. 3B(b)). Herein, the physical block a(S+M+1) containing part of the valid old data and the new data is temporarily linked as a substitute physical block 208. This is because the valid data in the physical block a(S+1) may become invalid in the next operation (for example, a write command) so that instantly moving all the valid data in the physical block a(S+1) to the substitute physical block a(S+M+1) may become meaningless. In the present example, the integrated content of the physical block a(S+1) and the substitute physical block a(S+M+1) is the content of the corresponding logical block a(1). The number of such temporary mother-child blocks (i.e., the physical block a(S+1) and the substitute physical block a(S+M+1)) can be determined according to the capacity of the buffer memory 110d in the controller 110, for example, five sets of such blocks are implemented. The operation for temporarily maintaining such a temporary relationship is usually referred to as opening mother-child blocks.

Thereafter, the controller 110 integrates the physical block a(S+1) and the substitute physical block a(S+M+1) into a physical block only when the contents of the physical block a(S+1) and the substitute physical block a(S+M+1) are to be actually integrated, so that the efficiency in using the blocks can be improved. Such an integration action is also referred to as closing mother-child blocks. For example, as shown in FIG. 3B(c), when the mother-child blocks are to be closed, the controller 110 copies the remaining valid data (i.e., the pages P4˜PN) in the physical block a(S+1) to the substitute physical block a(S+M+1) and then erases the physical block a(S+1) and links it to the spare area 206a. Meanwhile, the controller 110 links the substitute physical block a(S+M+1) to the data area 204a and changes the physical block corresponding to the logical block a1 to be the physical block a(S+M+1) in the logical-physical address mapping table. Herein, the system area 202a, the data area 204a, and the spare area 206a are logical groups of the physical blocks in the first plane 130a. Below, a system area 202b, a data area 204b, and a spare area 206b will be used for representing the logical groups of the physical blocks in the second plane 130b. Particularly, in the present exemplary embodiment, the controller 110 maintains two independent logical-physical address mapping tables respectively for the first plane 130a and the second plane 130b of the flash memory chip 130 for recording foregoing mapping relationship. In other words, in the present exemplary embodiment, two logical-physical address mapping tables are recorded and updated.

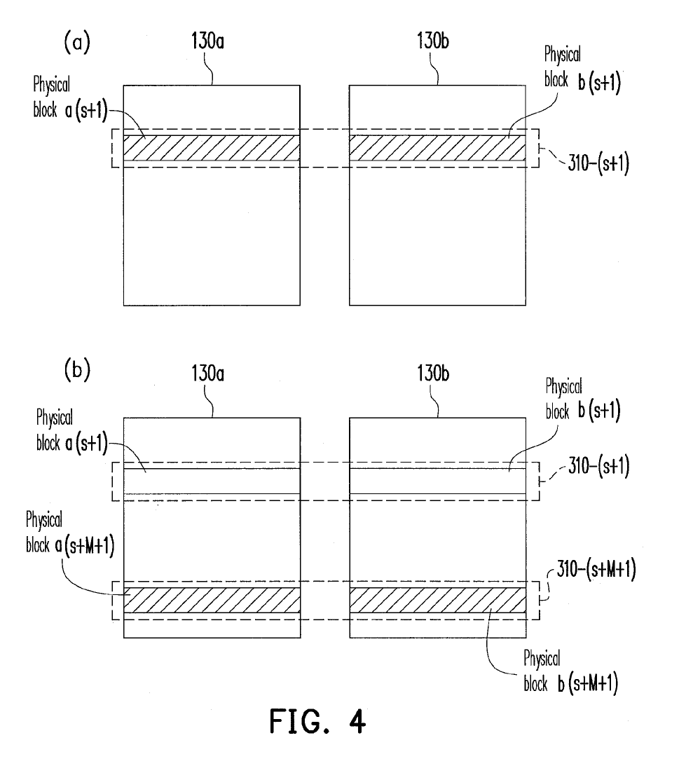

In addition, when the flash memory chip 130 is programmed (i.e., written or erased) in a multi-planes access mode, foregoing process of alternatively using the physical blocks in the data area 204a and the spare area 206a for writing data may also be carried out in unit of physical units. For example, as shown in FIG. 4, when the physical blocks in the physical unit 310-(S+1) contain valid data (i.e., the physical blocks a(S+1) and b(S+1) in the physical unit 310-(S+1) are currently linked to the data area 204a and the data area 204b respectively, as shown in FIG. 4(a)) and the host system 200 issues a write command to update data in the physical blocks a(S+1) and b(S+1) in the physical unit 310-(S+1), the controller 110 writes the data through a multi-planes write command (i.e., foregoing multi-planes access mode). In other words, the controller 110 respectively selects a physical block from the spare area 206a of the first plane 130a and the spare area 206b of the second plane 130b to form a physical unit (for example, the physical blocks a(S+M+1) and b(S+M+1) in the physical unit 310-(S+M+1)) for writing the data and substituting the physical blocks a(S+1) and b(S+1) in the physical unit 310-(S+1) (as shown in FIG. 4(b)). In this example, the controller 110 uses the physical units alternatively for writing the data, as shown in FIGS. 3A and 3B. Herein, two physical blocks in a physical unit can be programmed at the same time by executing only one command through the multi-planes access technique. Accordingly, the data accessing speed is increased. Besides, according to the block management method in the present exemplary embodiment, the physical blocks of each plane are managed individually. Accordingly, the controller 110 has to maintain and update two logical-physical address mapping tables at the same time when the multi-planes access is carried out.

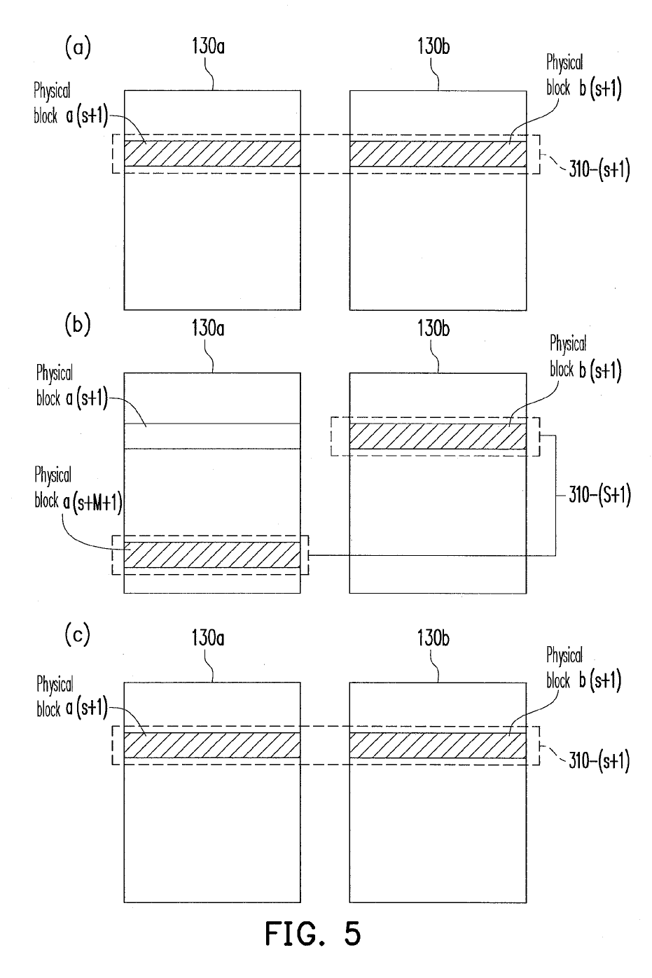

Additionally, in the present exemplary embodiment, the flash memory chip 130 may also access only one of the physical blocks (i.e., the physical block of the first plane or the physical block of the second plane) in a physical unit in a single plane access mode. For example, as shown in FIG. 5, when the physical blocks in the physical unit 310-(S+1) contain valid data (i.e., the physical blocks a(S+1) and b(S+1) in the physical unit 310-(S+1) are currently linked to the data area 204a and the data area 204b respectively, as shown in FIG. 5(a)) and the host system 200 issues a write command to update the data in the physical block a(S+1) of the first plane 130a in the physical unit 310-(S+1), the controller 110 selects a physical block from the spare area 206a of the first plane 130a (for example, the physical block a(S+M+1) of the first plane 130a in the physical units 310-(S+M+1)) through a single plane write command for writing the data and substituting the physical block a(S+1) of the first plane 130a in the physical unit 310-(S+1) (as shown in FIG. 5(b)). Besides, according to the block management method in the present exemplary embodiment, the physical blocks of each plane are managed individually. Accordingly, the controller 110 only maintains and updates the corresponding logical-physical address mapping table when the single plane access is carried out.

It should be mentioned that if the physical unit to be updated by the host system 200 is currently composed of two physical blocks having the simultaneously-operable relationship when the single plane write command is executed, the two physical blocks containing the new data in the physical unit do not have the simultaneously-operable relationship anymore after the single plane write command is executed. Thereafter, the physical unit composed of the physical blocks not having the simultaneously-operable relationship cannot be accessed in the multi-planes access mode, and accordingly the access speed thereof is slowed down. Thus, according to the block management method in another exemplary embodiment of the present invention, when a single plane write command is executed to a physical unit composed of physical blocks not having the simultaneously-operable relationship, a physical block which has the simultaneously-operable relationship with the other physical block in the physical unit is first selected from the spare area for writing the data, so that this physical unit is restored in to a physical unit to which a multi-planes access can be executed.

For example, after the data is written into the physical unit 310-(S+1) in the single plane access mode, as described above, the physical unit 310-(S+1) becomes containing two physical blocks a(S+M+1) and b(S+1) which do not have the simultaneously-operable relationship, and accordingly, the controller 110 cannot execute a multi-planes access to the physical unit 310-(S+1) composed of the physical blocks a(S+M+1) and b(S+1). In this case, if subsequently the host system 200 updates the physical block a(S+M+1) of the first plane 130a in the physical unit 310-(S+1), the controller 110 determines whether there is a physical block in the spare area 206a of the first plane 130a which has the simultaneously-operable relationship with the physical block b(S+1) (i.e., the physical block a(S+1)). If the physical block a(S+1) is currently linked to the spare area 206a (i.e., the physical block a(S+1) is a blank block), the controller 110 selects the physical block a(S+1) for writing the data and substituting the physical block a(S+M+1). Then the physical unit 310-(S+1) is restored into a physical unit to which a multi-planes access can be executed (as shown in FIG. 5(c)).

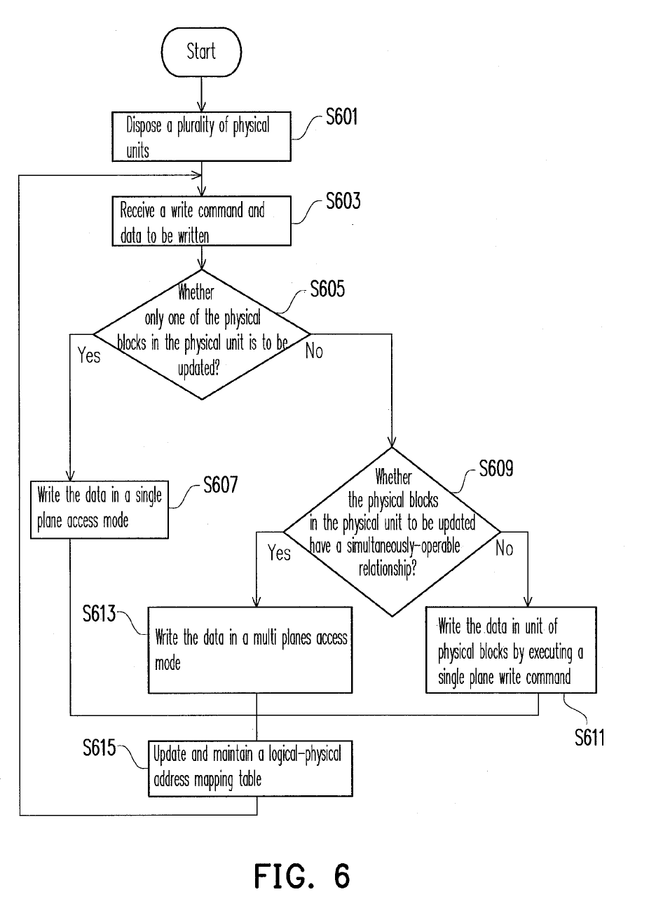

FIG. 6 is a flowchart of various block management steps according to an exemplary embodiment of the present invention. These steps are accomplished by executing the machine instructions of the memory management module 110b through the controller 110. It should be understood that the block management steps provided by the present invention are not limited to the execution sequence illustrated in FIG. 6, and those skilled in the art should be able to change the sequence of the block management steps according to the spirit of the present invention. It should be mentioned herein that the time out problem may only be caused when data is written into the flash memory chip 130 with multiple planes. Accordingly, the block management steps regarding the execution of a write command will be described below. The executions of a read command or other commands can be referred to conventional techniques therefore will not be described herein.

Referring to FIG. 6, in step S601, the controller 110 disposes a plurality of physical units, wherein each of the physical units includes one of the physical blocks of the first plane and one of the physical blocks of the second plane. In particular, when the flash memory storage system 100 is just manufactured (i.e., turned on for the first time), the controller 110 groups those physical blocks having the simultaneously-operable relationship into the same physical unit (as shown in FIG. 2).

Then, in step S603, a write command and data to be written are received from the host system 200. In step S605, whether the host system 200 is about to update the data in only one of the physical blocks in the physical units is determined. If it is determined in step S605 that the host system 200 is only about to update the data in one of the physical blocks belonged to the same physical unit (for example, the physical block a(S+1) of the first plane 130a in the physical unit 310-(S+1)), in step S607, the data is written in the single plane access mode (as shown in FIG. 5(b)). To be specific, in step S607, the controller 110 executes a single plane write command to select a physical block from the spare area of the plane to which the physical block to be updated belongs (for example, the first plane 130a) and write both valid old data and the new data into the selected physical block (as shown in FIG. 3B).

If it is determined in step S605 that the host system 200 is about to update the data in all the physical blocks belonged to the same physical unit, then in step S609, the controller 110 determines whether the physical blocks belonged to the same physical unit to be update have the simultaneously-operable relationship. To be specific, in step S609, the controller 110 determines whether the physical blocks belonged to the physical unit to be update have the simultaneously-operable relationship according to the specification regarding the execution of multi-planes access command in the data sheet of the flash memory chip 130. For example, if a physical block has an address N, the physical block having the simultaneously-operable relationship with this block has an address 1024+N.

If it is determined in step S609 that the physical blocks belonged to the physical unit to be updated do not have the simultaneously-operable relationship, in step S611, the controller 110 executes a single plane write command to write the data in unit of physical blocks. In other words, in step S611, the operation illustrated in FIGS. 3A and 3B is performed by executing two single plane write commands to write the data respectively into two physical blocks.

If it is determined in step S609 that the physical blocks in the physical unit to be updated have the simultaneously-operable relationship, then in step S613, the controller 110 writes the data in the multi-planes access mode. To be specific, in step S613, the controller 110 executes a multi-planes write command to respectively select a physical block having the simultaneously-operable relationship from the spare area 206a of the first plane 130a and the spare area 206b of the second plane 130b and write both valid old data and the new data into the selected physical blocks (as shown in FIG. 4(b)).

Thereafter, in step S615, the logical-physical address mapping tables are updated and maintained. Finally, the block management steps return to step S603 to wait for the next write command. Even though not shown in FIG. 6, it should be understood by those skilled in the art that the block management steps in FIG. 6 will be terminated after a shutdown or power-off instruction.

It should be mentioned that as described above, the physical blocks in a physical unit may not have the simultaneously-operable relationship anymore after a single plane write command is executed to the physical unit. Thus, according to another exemplary embodiment of the present invention, in step S607, whether there is a physical block in the spare area which has the simultaneously-operable relationship with the other physical block in the physical unit to be updated is further determined while selecting the physical block from the spare area, and if there is such a physical block, the physical block is selected for writing the data. Accordingly, the physical unit which cannot be executed with a multi-planes access can be restored into a physical unit for multi-planes access.

Additionally, the present exemplary embodiment is described with a flash memory chip having two planes as an example. However, the block management method in the present invention may also be applied to a flash memory chip having more than two planes.

As described above, in the block management method provided by the present invention, a logical-physical address mapping table is individually maintained for each plane in a flash memory chip having multiple planes, and whether a single plane write command or a multi-planes write command is executed is determined according to the address for writing the data. Thereby, unnecessary data moving can be reduced when a multi-planes access technique is adopted, and accordingly the time out problem can be avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A block management method, comprising:
providing a flash memory chip, wherein the flash memory chip comprises a first plane and a second plane, and the first plane and the second plane respectively have a plurality of physical blocks;
disposing a plurality of physical units, wherein each of the physical units comprises one of the physical blocks of the first plane and one of the physical blocks of the second plane, and the physical block of the first plane and the physical block of the second plane in each of the physical units have a simultaneously-operable relationship;
determining whether a host system is about to write data only into the physical block of the first plane in one of the physical units when the host system is about to write the data into the one of physical units;
writing the data into the physical block of the first plane in the one of the physical units in a single plane access mode when the host system is about to write the data only into the physical block of the first plane in the one of the physical units; and
writing the data into the physical block of the first plane and the physical block of the second plane in the one of the physical units in a multi-planes access mode when the host system is not about to write the data only into the physical block of the first plane in the one of the physical units, wherein the physical block of the first plane and the physical block of the second plane in the one of the physical units for writing the data have the simultaneously-operable relationship.

2. The block management method according to claim 1, further comprising:
disposing a plurality of logical blocks to be accessed by the host system; and
disposing a plurality of logical-physical address mapping tables for respectively recording a mapping relationship between each of the physical blocks of the first plane and the second plane and the logical blocks.

3. The block management method according to claim 1, further comprising grouping the physical blocks of the first plane into a first plane data area and a first plane spare area and grouping the physical blocks of the second plane into a second plane data area and a second plane spare area.

4. The block management method according to claim 3, wherein the step of writing the data into the physical block of the first plane in the one of the physical units in the single plane access mode comprises:
selecting a physical block from the first plane spare area of the first plane; and
writing the data into the physical block selected from the first plane spare area.

5. The block management method according to claim 3, wherein the step of writing the data into the physical block of the first plane and the physical block of the second plane in the one of the physical units in the multi-planes access mode comprises:
selecting a physical block from the first plane spare area of the first plane;
selecting a physical block from the second plane spare area of the second plane; and
writing the data into the physical blocks selected from the first plane spare area and the second plane spare area.

6. The block management method according to claim 4, wherein the step of selecting a physical block from the first plane spare area of the first plane comprises:
determining whether there is a physical block in the first plane spare area having the simultaneously-operable relationship with the physical block of the second plane in the one of the physical units;
selecting the physical block having the simultaneously-operable relationship with the physical block of the second plane in the one of the physical units from the first plane spare area if there is the physical block in the first plane spare area having the simultaneously-operable relationship with the physical block of the second plane in the one of the physical units; and
selecting any physical block from the first plane spare area if there is no physical block in the first plane spare area having the simultaneously-operable relationship with the physical block of the second plane in the one of the physical units.

7. A controller, suitable for managing a flash memory chip in a flash memory storage system, wherein the flash memory chip has a first plane and a second plane, and the first plane and the second plane respectively have a plurality of physical blocks, the controller comprising:
a microprocessor unit;
a flash memory interface module, coupled to the microprocessor unit; and
a buffer memory, coupled to the microprocessor unit; and
a memory management module, coupled to the microprocessor unit, wherein the memory management module has a plurality of machine instructions, which when executed by the microprocessor unit, to perform a plurality of block management steps to the flash memory chip, and the block management steps comprise:
disposing a plurality of physical units, wherein each of the physical units comprises one of the physical blocks of the first plane and one of the physical blocks of the second plane, and the physical block of the first plane and the physical block of the second plane in each of the physical units have a simultaneously-operable relationship;
determining whether a host system is about to write data only into the physical block of the first plane in one of the physical units when the host system is about to write the data into the line of physical units;
writing the data into the physical block of the first plane in the one of the physical units in a single plane access mode when the host system is about to write the data only into the physical block of the first plane in the one of the physical units; and
writing the data into the physical block of the first plane and the physical block of the second plane in the one of the physical units in a multi-planes access mode when the host system is not about to write the data only into the physical block of the first plane in the one of the physical units, wherein the physical block of the first plane and the physical block of the second plane in the one of the physical units for writing the data have the simultaneously-operable relationship.

8. The controller according to claim 7, wherein the block management steps further comprise:
disposing a plurality of logical blocks to be accessed by the host system; and
disposing a plurality of logical-physical address mapping tables for respectively recording a mapping relationship between each of the physical blocks of the first plane and the second plane and the logical blocks.

9. The controller according to claim 7, wherein the block management steps further comprise grouping the physical blocks of the first plane into a first plane data area and a first plane spare area and grouping the physical blocks of the second plane into a second plane data area and a second plane spare area.

10. The controller according to claim 9, wherein the step of writing the data into the physical block of the first plane in the one of the physical units in the single plane access mode comprises:
selecting a physical block from the first plane spare area of the first plane; and
writing the data into the physical block selected from the first plane spare area.

11. The controller according to claim 9, wherein the step of writing the data into the physical block of the first plane and the physical block of the second plane in the one of the physical units in the multi-planes access mode comprises:
selecting a physical block from the first plane spare area of the first plane;
selecting a physical block from the second plane spare area of the second plane; and
writing the data into the physical blocks selected from the first plane spare area and the second plane spare area.

12. The controller according to claim 10, wherein the step of selecting a physical block from the first plane spare area of the first plane comprises:
determining whether there is a physical block in the first plane spare area having the simultaneously-operable relationship with the physical block of the second plane in the one of the physical units;
selecting the physical block having the simultaneously-operable relationship with the physical block of the second plane in the one of the physical units from the first plane spare area if there is the physical block in the first plane spare area having the simultaneously-operable relationship with the physical block of the second plane in the one of the physical units; and
selecting any physical block from the first plane spare area if there is no physical block in the first plane spare area having the simultaneously-operable relationship with the physical block of the second plane in the one of the physical units.

13. The controller according to claim 7, wherein the flash memory storage system is a flash drive, a flash memory card, or a solid state drive (SSD).

14. A flash memory storage system, comprising:
a flash memory chip, having a first plane and a second plane, wherein the first plane and the second plane respectively have a plurality of physical blocks; and
a connector; and
a controller, electrically connected to the flash memory chip and the connector, wherein the controller executes a plurality of machine instructions of a memory management module to perform a plurality of block management steps, and the block management steps comprise:
disposing a plurality of physical units, wherein each of the physical units comprises one of the physical blocks of the first plane and one of the physical blocks of the second plane, and the physical block of the first plane and the physical block of the second plane in each of the physical units have a simultaneously-operable relationship;
disposing a plurality of physical units, wherein each of the physical units comprises one of the physical blocks of the first plane and one of the physical blocks of the second plane, and the physical block of the first plane and the physical block of the second plane in each of the physical units have a simultaneously-operable relationship;
determining whether a host system is about to write data only into the physical block of the first plane in one of the physical units when the host system is about to write the data into the line of physical units;
writing the data into the physical block of the first plane in the one of the physical units in a single plane access mode when the host system is about to write the data only into the physical block of the first plane in the one of the physical units; and
writing the data into the physical block of the first plane and the physical block of the second plane in the one of the physical units in a multi-planes access mode when the host system is not about to write the data only into the physical block of the first plane in the one of the physical units, wherein the physical block of the first plane and the physical block of the second plane in the one of the physical units for writing the data have the simultaneously-operable relationship.

15. The flash memory storage system according to claim 14, wherein the block management steps further comprise:
disposing a plurality of logical blocks to be accessed by the host system; and
disposing a plurality of logical-physical address mapping tables for respectively recording a mapping relationship between each of the physical blocks of the first plane and the second plane and the logical blocks.

16. The flash memory storage system according to claim 14, wherein the block management steps further comprise grouping the physical blocks of the first plane into a first plane data area and a first plane spare area and grouping the physical blocks of the second plane into a second plane data area and a second plane spare area.

17. The flash memory storage system according to claim 16, wherein the step of writing the data into the physical block of the first plane in the one of the physical units in the single plane access mode comprises:
selecting a physical block from the first plane spare area of the first plane; and
writing the data into the physical block selected from the first plane spare area.

18. The flash memory storage system according to claim 16, wherein the step of writing the data into the physical block of the first plane and the physical block of the second plane in the one of the physical units in the multi-planes access mode comprises:
selecting a physical block from the first plane spare area of the first plane;
selecting a physical block from the second plane spare area of the second plane; and
writing the data into the physical blocks selected from the first plane spare area and the second plane spare area.

19. The flash memory storage system according to claim 17, wherein the step of selecting a physical block from the first plane spare area of the first plane comprises:
determining whether there is a physical block in the first plane spare area having the simultaneously-operable relationship with the physical blocks of the second plane in the one of the physical units;
selecting the physical block having the simultaneously-operable relationship with the physical block of the second plane in the one of the physical units from the first plane spare area if there is the physical block in the first plane spare area having the simultaneously-operable relationship with the physical block of the second plane in the one of the physical units; and
selecting any physical block from the first plane spare area if there is no physical block in the first plane spare area having the simultaneously-operable relationship with the physical block of the second plane in the one of the physical units.

20. A block management method, comprising:
providing a flash memory chip, wherein the flash memory chip comprises multiple planes, and each of the planes has a plurality of physical blocks;
disposing a plurality of physical units, wherein each of the physical units comprises one of the physical blocks of each of the planes, and the physical blocks in each of the physical units have a simultaneously-operable relationship;
determining whether a host system is about to write data into all the physical blocks in one of the physical units when the host system is about to write the data into the one of the physical units;
writing the data in a single plane access mode when the host system is not about to write the data into all the physical blocks in the one of the physical units; and
writing the data in a multi-planes access mode when the host system is about to write the data into all the physical blocks in the one of the physical units, wherein the physical blocks in the one of the physical units for writing the data have the simultaneously-operable relationship.
